(19) United States
(12) Patent Application Publication
(10) Pub. No.: US 2021/0268645 A1
(43) Pub. Date: Sep. 2, 2021

(54) CONTROL APPARATUS, CONTROL METHOD, AND PROGRAM

(71) Applicant: SONY CORPORATION, TOKYO (JP)

(72) Inventors: KIYOKAZU MIYAZAWA, TOKYO (JP); KAZUO HONGO, TOKYO (JP); MASAYA KINOSHITA, TOKYO (JP); YOHEI FUKUMA, TOKYO (JP); YASUFUMI HAYASHIDA, TOKYO (JP)

(21) Appl. No.: 17/250,320

(22) PCT Filed: Jul. 1, 2019
(86) PCT No.: PCT/JP2019/026103

§ 371 Date: Jan. 4, 2021

(30) Foreign Application Priority Data
Jul. 12, 2018 (JP) 2018-132569

(51) Int. Cl. B25J 9/16; G05B 13/02

(52) U.S. Cl. CPC B25J 9/163; G05B 13/0265

(57) ABSTRACT

A control apparatus including: a control unit (110) configured to compare a weight related to a current operating environment calculated based on detected information that is detected at a current position of a control object with a predetermined threshold that is set to determination criteria of a known operating environment and, based on a comparison result, determine an operation of the control object in the current operating environment.

### TECHNICAL FIELD

The present disclosure relates to a control apparatus, a control method, and a program.

### BACKGROUND ART

Conventionally, various techniques for causing a robot to execute an operation in accordance with a state of a surrounding environment of the robot based on information on the surrounding environment have been developed.

For example, PTL 1 below discloses a technique used when a state of an environment changes due to disturbance or the like to cause a robot to perform an operation suitable for a state after the change. For example, the robot learns, in advance, a state of the environment in which an operation is to be performed and derives candidates of an operation to be actually performed. When a difference arises between a state of the environment during learning and a state of the environment after the learning due to the effect of disturbance, the robot selects an operation suitable for the environment after the learning from the candidates and performs the selected operation.

### CITATION LIST

### Patent Literature

[PTL 1]

JP 2006-320997A

### SUMMARY

### Technical Problem

However, with the technique described in PTL 1, candidates of an operation to be selected when a difference arises between the state of the environment during learning and the state of the environment after the learning are derived when the robot learns the environment. In addition, the technique described in PTL 1 does not take into consideration adding and updating operations among the candidates based on feedback on the state of the environment and an execution result of an operation. Therefore, when a significant difference arises between the state of the environment during learning and the state of the environment after the learning, a situation may occur where an operation derived in advance is not suitable for the environment after the learning.

In consideration thereof, the present disclosure proposes a novel and improved control apparatus, control method, and program capable of determining an operation that is suitable for a current operating environment.

### Solution to Problem

The present disclosure proposes a control apparatus including: a control unit configured to compare a weight related to a current operating environment calculated based on detected information that is detected at a current position of a control object with a predetermined threshold that is set to determination criteria of a known operating environment and, based on a comparison result, determine an operation of the control object in the current operating environment.

In addition, the present disclosure proposes a control method executed by a processor, the method including: comparing a weight related to a current operating environment calculated based on detected information that is detected at a current position of a control object with a predetermined threshold that is set to determination criteria of a known operating environment and, based on a comparison result, determining an operation of the control object in the current operating environment.

Furthermore, the present disclosure proposes a program for causing a computer to function as: a control unit configured to compare a weight related to a current operating environment calculated based on detected information that is detected at a current position of a control object with a predetermined threshold that is set to determination criteria of a known operating environment and, based on a comparison result, determine an operation of the control object in the current operating environment.

### Advantageous Effects of Invention

As described above, according to the present disclosure, an operation suitable for a current operating environment can be determined. It should be noted that the advantageous effect described above is not necessarily restrictive and, in addition to the advantageous effect described above or in place of the advantageous effect described above, any of the advantageous effects described in the present specification or other advantageous effects that can be comprehended from the present specification may be produced.

### BRIEF DESCRIPTION OF DRAWINGS

FIG. 1 is a diagram showing an outline of a control system according to an embodiment of the present disclosure.

FIG. 2 is a flow chart showing an example of a flow of main processing according to a comparative example of the present disclosure.

FIG. 3 is a flow chart showing an example of a flow of detailed processing of operation determination processing according to the comparative example.

FIG. 4 is a block diagram showing a functional configuration example of a robot according to the embodiment of the present disclosure.

FIG. 5 is a diagram showing an example of determination criteria and detected information according to the embodiment.

FIG. 6 is a diagram showing criteria of a weight of an environment according to the embodiment.

FIG. 7 is a diagram showing an example of a known operation according to the embodiment.

FIG. 8 is a diagram showing an example of detected information in a different environment according to the embodiment.

FIG. 9 is a diagram showing an example of a manual according to the embodiment.

FIG. 10 is a block diagram showing a functional configuration example of a cloud server according to the embodiment.

FIG. 11 is a flow chart showing an example of a flow of main processing according to the embodiment.

FIG. 12 is a flow chart showing an example of a flow of detailed processing of operation determination processing according to the embodiment.

FIG. 13 is a flow chart showing an example of a flow of operation information update processing according to the embodiment.

FIG. 14 is a flow chart showing an example of a flow of operation determination processing after update according to the embodiment.

FIG. 15 is a block diagram showing an example of a hardware configuration of a robot according to the embodiment.

### DESCRIPTION OF EMBODIMENTS

Hereinafter, a preferred embodiment of the present disclosure will be described in detail with reference to the accompanying drawings. In the present specification and the drawings, components substantially having the same functional configuration will be denoted by the same reference signs and overlapping descriptions thereof will be omitted.

Descriptions will be given in the following order.

1. Embodiment

2. Modifications

3. Example of hardware configuration

4. Summary

### 1. Embodiment

<1.1. Overview>

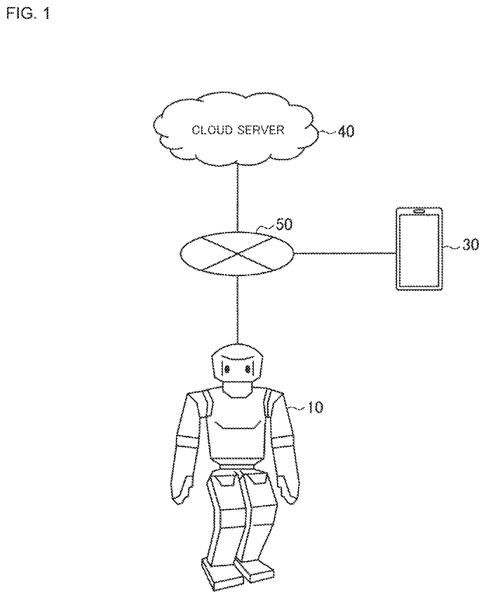

Hereinafter, an overview of an embodiment of the present disclosure will be described with reference to FIGS. 1 to 3.

<1.1.1. System Configuration>

First, a control system according to the embodiment will be described with reference to FIG. 1. FIG. 1 is a diagram showing an outline of a control system according to the embodiment of the present disclosure. As shown in FIG. 1, the control system according to the present embodiment includes a robot 10, an external terminal 30 (an external apparatus), a cloud server 40, and a network 50.

(1) Robot 10

The robot 10 is an example of a control apparatus and a control object according to the present embodiment. The robot 10 can be an apparatus (a machine) capable of operating autonomously using electric and/or magnetic action. For example, the robot 10 may be, but is not limited to, a humanoid robot, a quadruped robot, an autonomous car, a drone, an industrial robot (for example, a robot that assembles machinery or the like), a service robot (for example, a medical robot such as a surgical robot or a cooking robot), or a toy robot.

The robot 10 is connected to the external terminal 30 via the network 50 and is capable of transmitting and receiving information to and from the external terminal 30. In addition, the robot 10 is also connected to the cloud server 40 via the network 50 and is capable of transmitting and receiving information to and from the cloud server 40.

(2) External Terminal 30

The external terminal 30 is a terminal which is capable of accepting input of information by a user and outputting information to the user. For example, the external terminal 30 may be a mobile phone, a smartphone, a tablet, a wearable device, a general-purpose computer, a stationary or autonomous mobile dedicated apparatus, or the like. The external terminal 30 is connected to the robot 10 via the network 50 and is capable of transmitting and receiving information to and from the robot 10. In addition, the external terminal 30 is also connected to the cloud server 40 via the network 50 and is capable of transmitting and receiving information to and from the cloud server 40.

For example, the external terminal 30 can include an input apparatus to be used by the user to input information such as a mouse, a keyboard, a touch panel, a button, a microphone, a switch, or a lever. In addition, for example, the external terminal 30 can include an input apparatus such as a remote control apparatus that utilizes infrared light or other radio waves. By operating the input apparatus, the user of the external terminal 30 can input various kinds of data and issue instructions to perform processing operations with respect to the external terminal 30.

In addition to the above, the input apparatus can be constituted by an apparatus that senses information related to the user. For example, the input apparatus can include various types of sensors such as an image sensor (for example, a camera), a depth sensor (for example, a stereo camera), an acceleration sensor, a gyroscope sensor, a geomagnetic sensor, a light sensor, a sound sensor, a ranging sensor, and a force sensor. Furthermore, the input apparatus may acquire information related to a state of the external terminal 30 itself such as a posture or a movement speed of the external terminal 30 as well as information related to a surrounding environment of the external terminal 30 such as brightness or a noise level of the surroundings of the external terminal 30. In addition, the input apparatus may include a GNSS (Global Navigation Satellite System) module which receives a GNSS signal from a GNSS satellite (for example, a GPS signal from a GPS (Global Positioning System) satellite) to measure positional information including a latitude, a longitude, and an altitude of the apparatus. Alternatively, with respect to positional information, the input apparatus may sense a position from Wi-Fi (registered trademark), transmission and reception to and from a mobile phone, a PHS, a smartphone, or the like, short-range communication, and the like.

The external terminal 30 can include an apparatus capable of visually or auditorily notifying the user of acquired information. Examples of such an apparatus include display apparatuses such as a CRT display apparatus, a liquid crystal display apparatus, a plasma display apparatus, an EL display apparatus, a laser projector, an LED projector, and a lamp, audio output apparatuses such as a speaker and headphones, and printer apparatuses. For example, the external terminal 30 outputs results obtained through various kinds of processing performed by the robot 10 or the cloud server 40. Specifically, the display apparatus outputs, in various formats such as a text, an image, a table, and a graph, results obtained through various kinds of processing performed by the robot 10 or the cloud server 40. On the other hand, the audio output apparatus converts an audio signal constituted by reproduced audio data, acoustic data, or the like into an analog signal and auditorily outputs the converted analog signal.

(3) Cloud Server 40

The cloud server 40 is a server apparatus having a function of storing information related to control of the robot 10. For example, the cloud server 40 stores information related to operations of the robot 10. The information can be updated based on information transmitted to and received from the robot 10. In addition, the information may be updated by the user via the external terminal 30 or the like.

(4) Network 50

The network 50 has a function of connecting the robot 10, the external terminal 30, and the cloud server 40 to one another. The network 50 may include a public line network such as the Internet, a telephone line network, or a satellite communication network, various types of LAN (Local Area Network) including the Ethernet (registered trademark), a WAN (Wide Area Network), or the like. In addition, the network 50 may include a dedicated line network such as an IP-VPN (Internet Protocol-Virtual Private Network). Furthermore, the network 50 may include a wireless communication network such as Wi-Fi (registered trademark) or Bluetooth (registered trademark).

21 1.1.2. Comparative Example>

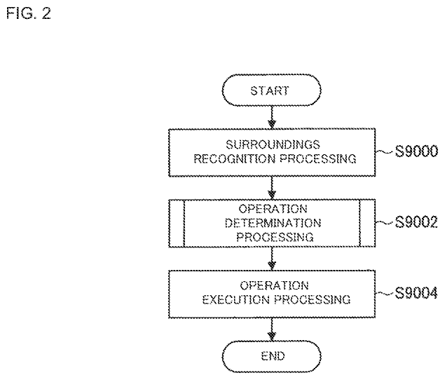

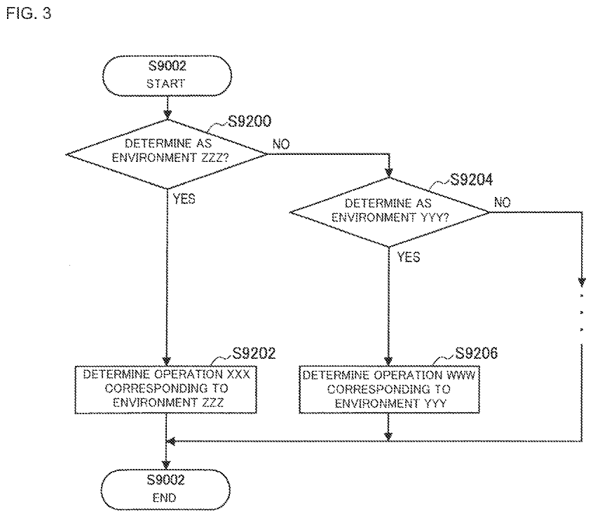

A comparative example of the present disclosure will now be described in order to clearly demonstrate features of the present embodiment. Hereinafter, a flow of processing according to the comparative example will be described with reference to FIGS. 2 and 3.

FIG. 2 is a flow chart showing an example of a flow of main processing according to the comparative example of the present disclosure. For example, as shown in FIG. 2, a robot 20 first performs surroundings recognition processing for recognizing a state of a surrounding environment of the robot 20 based on information detected by sensors or the like (step S9000). Next, based on a result of the surroundings recognition processing, the robot 20 performs operation determination processing for determining an operation to be executed by the robot 20 (step S9002). Detailed processing of the operation determination processing will be described later. Finally, the robot 20 executes the operation determined by the operation determination processing (step S9004) and ends the processing.

FIG. 3 is a flow chart showing an example of a flow of detailed processing of the operation determination processing (step S9002 shown in FIG. 2) according to the comparative example of the present disclosure. For example, as shown in FIG. 3, the robot 20 first confirms whether or not a surrounding environment of the robot 20 is an environment ZZZ based on a result of the surroundings recognition processing (step S9200). When the surrounding environment is the environment ZZZ (YES in step S9200), the robot 20 makes a determination to execute an operation XXX that corresponds to the environment ZZZ (step S9202) and ends the operation determination processing of step S9002.

On the other hand, when the surrounding environment is not the environment ZZZ (NO in step S9200), the robot 20 confirms whether or not the surrounding environment is an environment YYY (step S9204). When the surrounding environment is the environment YYY (YES in step S9204), the robot 20 makes a determination to execute an operation WWW that corresponds to the environment YYY (step S9206) and ends the operation determination processing of step S9002. When the surrounding environment is not the environment YYY (NO in step S9204), the robot 20 repeats the processing described above until an operation that corresponds to the environment determined by surroundings confirmation processing is determined.

The operation determined by the processing described above can be executed by the robot 20 in various kinds of environments. For example, various kinds of environments include a known operating environment and an unknown operating environment. A known operating environment is, for example, an operating environment that the robot 20 has already learned through surroundings recognition processing or the like, an environment in which the robot 20 operates on a routine basis, or the like. An unknown operating environment is an operating environment that the robot 20 has never learned through surroundings recognition processing or the like, an environment in which the robot 20 has never operated, or the like. In addition, when a difference has arisen between an operating environment at the time of last learning and a current operating environment, even a learned operating environment will be considered an unknown operating environment.

When an operating environment of a current position of the robot 20 is a known operating environment, the robot 20 can appropriately execute the operation determined in the processing described above. Whether or not the operation has been appropriately executed is determined based on whether or not the operation is successful, whether or not an execution result is as expected by the user, or the like. For example, when the execution result of the operation is a success or a result expected by the user, it is determined that the operation has been appropriately executed. In addition, when the execution result of the operation is a failure or not an execution result expected by the user, it is determined that the operation has not been appropriately executed.

On the other hand, when an operating environment of the current position of the robot 20 is an unknown operating environment, the robot 20 may not be able to appropriately execute the operation determined in the processing described above. For example, when sufficient information for performing operation determination processing in an environment visited for the first time cannot be acquired, there is a possibility that the robot 20 may make an erroneous determination with respect to operation determination and an operation may fail. In addition, when the current operating environment is determined to be an environment similar to a known operating environment and an operation that corresponds to the known operating environment is executed in the current operating environment, there is a possibility that a slight difference between the current operating environment and the known operating environment may end up having a significant effect and an operation may fail.

<1.1.3. Clarification of Issue>

The robot 20 according to the comparative example described above executes an operation that corresponds to an operating environment determined by surroundings recognition processing. The operation is an operation prepared in advance before the robot 20 performs the surroundings recognition processing. Therefore, in a case where an operating environment when performing surroundings recognition processing differs from an operating environment in which the operation has been prepared, the robot 20 may not be able to perform an appropriate operation.

The robot 10 according to the present embodiment was created with the situation described above as a viewpoint. The robot 10 according to the present embodiment calculates a weight related to a current operating environment based on detected information that is detected at a current position of a control object. It should be noted that, hereinafter, a weight related to the current operating environment will also be referred to as an environmental weight. Next, the robot 10 compares a predetermined threshold that is set to determination criteria of a known operating environment with the calculated environmental weight. In addition, based on a comparison result, the robot 10 determines an operation of the control object in the current operating environment. Accordingly, the robot 10 can determine an operation suitable for the current operating environment. Hereinafter, contents of the present embodiment will be sequentially described in detail.

<1.2 Functional Configuration Example>

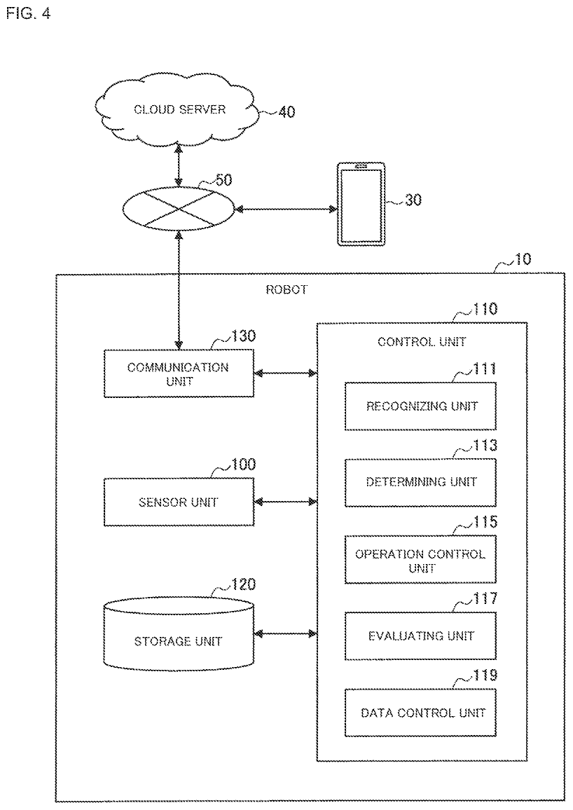

A functional configuration example of the robot 10 and the cloud server 40 according to the present embodiment will now be described with reference to FIGS. 4 to 10.

<1.2.1. Functional Configuration Example of Robot 10>

First, a functional configuration example of the robot 10 according to the present embodiment will be described with reference to FIGS. 4 to 9. FIG. 4 is a block diagram showing a functional configuration example of the robot 10 according to the present embodiment. As shown in FIG. 4, the robot 10 according to the present embodiment includes a sensor unit 100, a control unit 110, a storage unit 120, and a communication unit 130.

(1) Sensor Unit 100

The sensor unit 100 has a function of sensing the surroundings of the robot 10. The sensor unit 100 outputs information detected by the sensing as detected information to the control unit 110. The sensor unit 100 can include a variety of sensors. For example, the sensor unit 100 can include a camera, a thermal camera, a depth sensor, a microphone (hereinafter, also referred to as a mike), a pressure sensor, an electrostatic sensor, a distortion sensor, an inertial sensor, and a biometric sensor. The sensor unit 100 may include one of or a combination of a plurality of these sensors or may include a device of the same type in plurality.

A camera is an imaging apparatus such as an RGB camera which has a lens system, a drive system, and an imaging element and which captures an image (a still image or a moving image). A thermal camera is an imaging apparatus that uses infrared light or the like to capture a captured image including information on a temperature of an imaging object. A depth sensor is an apparatus that acquires depth information such as an infrared ranging apparatus, an ultrasonic ranging apparatus, LiDAR (Laser Imaging Detection and Ranging), or a stereo camera. A microphone is an apparatus which collects ambient sound and which outputs audio data having been converted into a digital signal via an amplifier and an ADC (Analog Digital Converter). A pressure sensor is an apparatus that detects pressure applied from the outside. An electrostatic sensor is an apparatus which detects a change in capacitance and which is capable of, for example, detecting proximity of a human body or the like. A distortion sensor is an apparatus which detects an elongation or a contraction that is generated when a tensile force or a compressive force is applied from the outside. An inertial sensor is an apparatus that detects acceleration and an angular velocity. A biometric sensor is an apparatus that detects biological information such as a pulse and body temperature.

The sensor unit 100 senses information based on control by the control unit 110. For example, the control unit 110 is capable of controlling a zoom factor and an imaging direction of the camera.

It should be noted that the sensor unit 100 may include an arbitrary component capable of sensing other than the components described above. In addition, the sensor unit 100 can include various types of sensors such as a geomagnetic sensor, a light sensor, and an illuminance sensor.

Detected information that is detected by the sensor unit 100 is used for a comparison with determination criteria being set for each known environment when the control unit 110 recognizes a current operating environment. Therefore, the sensor unit 100 desirably includes a sensor for detecting detected information that can be compared with the determination criteria. In addition, the detected information can include answers to queries directed to people in the surroundings and to other robots.

(2) Control Unit 110

The control unit 110 has a function of controlling an entire operation by the robot 10. In order to realize this function, as shown in FIG. 4, the control unit 110 according to the present embodiment includes a recognizing unit 111, a determining unit 113, an operation control unit 115, an evaluating unit 117, and a data control unit 119.

(2-1) Recognizing Unit 111

The recognizing unit 111 has a function of recognizing a surrounding environment of the robot 10. For example, based on detected information input from the sensor unit 100, the recognizing unit 111 recognizes what kind of operating environment the current operating environment of the robot 10 is. Specifically, the recognizing unit 111 compares the detected information with determination criteria that is set to a known environment. In addition, the recognizing unit 111 outputs information related to the recognized operating environment to the determining unit 113. When a plurality of known environments exist, the determination criteria can be set to each of the plurality of known environments.

(Determination Criteria)

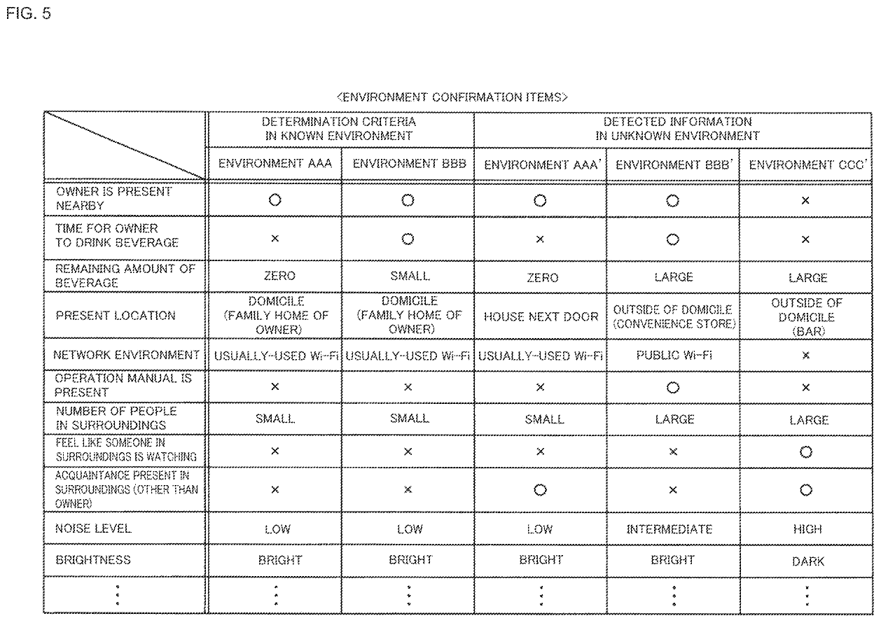

The larger the number of determination criteria that is set to known operating environments, the greater the detail in which the recognizing unit 111 can recognize a difference between the current operating environment and the known operating environments. An example of determination criteria will now be described with reference to FIG. 5. FIG. 5 is a diagram showing an example of determination criteria and detected information according to the embodiment of the present disclosure. FIG. 5 shows, as an example of determination criteria, determination criteria that is set to each of an environment AAA and an environment BBB which are known operating environments. Hereinafter, it is assumed that the environment AAA is a usual operating environment of a robot 10-A and the environment BBB is a usual operating environment of a robot 10-B.

With respect to the environment AAA shown in FIG. 5, determination criteria are set which require that an owner is present nearby, it is not time for the owner to drink a beverage, a remaining amount of the beverage is zero, a current location is a domicile (a family home of the owner), and a network environment is usually used Wi-Fi (registered trademark). In addition, with respect to the environment AAA, determination criteria are set which require that an operation manual is not present, the number of people in the surroundings is small, it does not feel like someone in the surroundings is watching, there are no acquaintances in the surroundings other than the owner, a noise level is low, and brightness is bright.

In addition, with respect to the environment BBB shown in FIG. 5, determination criteria are set which require that an owner is present nearby, it is time for the owner to drink a beverage, a remaining amount of the beverage is small, a current location is a domicile (a family home of the owner), and a network environment is usually used Wi-Fi (registered trademark). In addition, with respect to the environment BBB, determination criteria are set which require that an operation manual is not present, the number of people in the surroundings is small, it does not feel like someone in the surroundings is watching, there are no acquaintances in the surroundings other than the owner, a noise level is low, and brightness is bright.

A criterion requiring that “it is time for the owner to drink a beverage” which is one of the determination criteria shown in FIG. 5 is provided in order to, for example, determine whether or not the robot 10 is to propose that the owner drink a beverage. In addition, “a remaining amount of the beverage” is provided in order to, for example, determine whether or not the robot 10 orders a beverage when the remaining amount of the beverage is small or zero.

(Comparison with Determination Criteria)

The recognizing unit 111 compares detected information with each item of the determination criteria described above, confirms whether or not the detected information and the determination criteria match each other, and recognizes a known operating environment that corresponds to the determination criteria matching the detected information as the current operating environment. For example, the recognizing unit 111 compares the determination criteria that correspond to the environment AAA with the detected information in the current operating environment. As a result of the comparison, when the determination criteria that correspond to the environment AAA match the detected information in the current operating environment, the recognizing unit 111 recognizes the current operating environment as the environment AAA. On the other hand, when the determination criteria that correspond to the environment AAA do not match the detected information in the current operating environment, the recognizing unit 111 compares determination criteria that correspond to another known environment such as the environment BBB with the detected information in the current operating environment. As a result of the comparison, when the environment BBB matches the detected information in the current operating environment, the recognizing unit 111 recognizes the current operating environment as the environment BBB. It should be noted that, when there is no known operating environment of which determination criteria match the detected information, the recognizing unit 111 recognizes that the current operating environment is an unknown operating environment.

Once again referring to FIG. 5, a determination example of the operating environment of the robot 10 will now be described. FIG. 5 shows, as an example of detected information, detected information in each of an environment AAA′, an environment BBB′, and an environment CCC′ which are unknown operating environments.

First, an example where the robot 10-A of which a usual operating environment is the environment AAA is present in the environment AAA′ will be described. Detected information in the environment AAA′ shown in FIG. 5 specifically indicates that an owner is present nearby, it is not time for the owner to drink a beverage, a remaining amount of the beverage is zero, a current location is a house next door, and a network environment is usually used Wi-Fi (registered trademark). The detected information in the environment AAA′ also indicates that an operation manual is not present, the number of people in the surroundings is small, it does not feel like someone in the surroundings is watching, there is an acquaintance in the surroundings other than the owner, a noise level is low, and brightness is bright. Since a comparison between the detected information in the environment AAA′ and the determination criteria of the environment AAA that is a known environment reveals that, although there are many points that match, there are also points that do not match, the robot 10-A recognizes that the environment AAA′ and the environment AAA are different environments. For example, the environment AAA′ is not a domicile but a house next door. Accordingly, the robot 10-A present in the environment AAA′ can recognize that, for example, the robot 10-A is visiting the house next door and the house next door is an environment that is relatively close to the usual environment AAA.

However, it cannot be said that the detected information and the determination criteria that correspond to the environment AAA match each other. Therefore, since the environment AAA′ and the environment AAA are environments that are relatively close to each other but are nevertheless different environments, the robot 10-A recognizes that the environment AAA′ is an unknown operating environment. By recognizing that the environment AAA′ and the environment AAA are different environments, the robot 10-A can avoid executing, in the environment AAA′, operations performed in the usual environment AAA without modification and can execute operations that are more suitable for the environment AAA′. For example, when the robot 10-A detects that the remaining amount of a beverage in the environment AAA′ is zero, instead of immediately ordering the beverage, the robot 10-A determines whether or not to order the beverage after confirming whether or not an order should be placed with a person in the surroundings or the like. Accordingly, the robot 10-A can avoid a risk of performing a wrong operation. In addition, the robot 10-A declares to people in the surroundings that the beverage is to be ordered and places an order for the beverage while eliciting reactions of the people in the surroundings or the like. Accordingly, by giving the people in the surroundings time for feedback, the robot 10-A can avoid a risk of performing a wrong operation.

Next, an example where the robot 10-B of which a usual operating environment is the environment BBB is present in the environment BBB′ will be described. Detected information in the environment BBB′ shown in FIG. 5 specifically indicates that an owner is present nearby, it is time for the owner to drink a beverage, a remaining amount of the beverage is large, a current location is outside of domicile (a convenience store), and a network environment is public Wi-Fi (registered trademark). The detected information in the environment BBB′ also indicates that an operation manual is present, the number of people in the surroundings is large, it does not feel like someone in the surroundings is watching, there are no acquaintances in the surroundings other than the owner, a noise level is intermediate, and brightness is bright. Since a comparison between the detected information in the environment BBB′ and the determination criteria of the environment BBB that is a known environment reveals that there are more points that do not match than there are points that match, the robot 10-B recognizes that the environment BBB′ and the environment BBB are different environments. For example, a current location of the environment BBB′ is not a domicile but outside of domicile (a convenience store). Accordingly, the robot 10-B in the environment BBB′ can recognize that, for example, the robot 10-B is at the convenience store for shopping and the convenience store is an environment that differs from the usual environment BBB. In addition, the robot 10-B can also operate according to a manual of the convenience store. For example, the robot 10-B may acquire the manual by communicating with a terminal installed in the convenience store or acquire the manual by reading a QR code (registered trademark) presented at the storefront. Furthermore, the robot 10-B may acquire a manual being distributed by an in-store network. Accordingly, in addition to operating as a customer, the robot 10-B visiting the convenience store may operate as a sales clerk according to the manual. By having the robot 10-B operate as a sales clerk, customers are encouraged to make queries regarding availability of a product or a position of a product. In addition, the robot 10-B can also shorten a wait time of customers at a cashier.

Next, an example where the robot 10-A of which a usual operating environment is the environment AAA is present in an environment CCC will be described. Detected information in the environment CCC shown in FIG. 5 specifically indicates that an owner is not present nearby, it is not time for the owner to drink a beverage, a remaining amount of the beverage is large, a current location is outside of domicile (a bar), and a network environment is not available. The detected information in the environment CCC also indicates that an operation manual is not present, the number of people in the surroundings is large, it feels like someone in the surroundings is watching, there is an acquaintance in the surroundings other than the owner, a noise level is high, and brightness is dark. Since a comparison between the detected information in the environment CCC and the determination criteria of the environment AAA that is a known environment reveals that there are no points that match, the robot 10-A recognizes that the environment CCC and the environment AAA are completely different environments.

When a current position is recognized based on positional information acquired by GPS, the robot 10 may erroneously recognize the current position. For example, when the owner resides in a housing complex such as a condominium and the robot 10 is in the house next door in the same condominium, positional information acquired by GPS may indicate the same position as the domicile. Therefore, when recognizing a current position, by using image analysis information obtained by analyzing an image captured by a camera or the like in addition to positional information, a current operating environment can be detected with greater accuracy. It should be noted that using image analysis information is also effective when the domicile and a house next door share the same floor plan.

(Comparison with Weight)

In addition, the recognizing unit 111 may recognize what kind of operating environment the current operating environment of the robot 10 is based on a weight. For example, the recognizing unit 111 calculates an environmental weight related to a current operating environment based on detected information that is detected at a current position of the robot 10. Next, the robot 10 compares a predetermined threshold that is set to determination criteria of a known operating environment with the calculated environmental weight. In addition, the recognizing unit 111 recognizes the current operating environment based on a result of the comparison.

Specifically, the recognizing unit 111 calculates an environmental weight based on detected information. The recognizing unit 111 compares the calculated environmental weight with a predetermined threshold that is set to determination criteria corresponding to the detected information. When comparing the environmental weight and the predetermined threshold with each other, for example, the recognizing unit 111 compares the predetermined threshold with the environmental weight for each determination criterion. Specifically, based on the detected information, the recognizing unit 111 calculates a plurality of environmental weights that respectively correspond to a plurality of determination criteria. In addition, the recognizing unit 111 compares a predetermined threshold that is set to a determination criterion that correspond to each of the plurality of calculated environmental weights with each of the plurality of calculated environmental weights. As a result of the comparison, when the environmental weight is equal to or more than the predetermined threshold, for example, the recognizing unit 111 determines that the current operating environment is the same environment as a known operating environment. In addition, when the environmental weight is less than the predetermined threshold, for example, the recognizing unit 111 determines that the current operating environment is an environment that differs from the known operating environment.

Furthermore, for example, the recognizing unit 111 may collectively compare determination criteria with an environmental weight. Specifically, the recognizing unit 111 calculates a sum of environmental weights calculated with respect to each of a plurality of determination criteria and a sum of predetermined thresholds set to each of the plurality of determination criteria. In addition, the recognizing unit 111 compares the calculated sum of the environmental weights and the calculated sum of the predetermined thresholds with each other. As a result of the comparison, when the sum of the environmental weights is equal to or more than the sum of the predetermined thresholds, for example, the recognizing unit 111 determines that the current operating environment is the same environment as a known operating environment. In addition, when the sum of the environmental weights is less than the sum of the predetermined thresholds, for example, the recognizing unit 111 determines that the current operating environment is an environment that differs from the known operating environment. The recognizing unit 111 may determine that the current operating environment is an environment that differs from the known operating environment when the sum of the environmental weights is less than the sum of the predetermined thresholds. In addition, the recognizing unit 111 may determine that the current operating environment is the same environment as the known operating environment when the sum of the environmental weights is equal to or more than the sum of the predetermined thresholds.

It should be noted that the recognizing unit 111 need not necessarily calculate environmental weights with respect to all determination criteria and compare predetermined thresholds of all determination criteria with environmental weights. The recognizing unit 111 may calculate environmental weights with respect to a part of determination criteria and compare predetermined thresholds of the part of determination criteria with environmental weights.

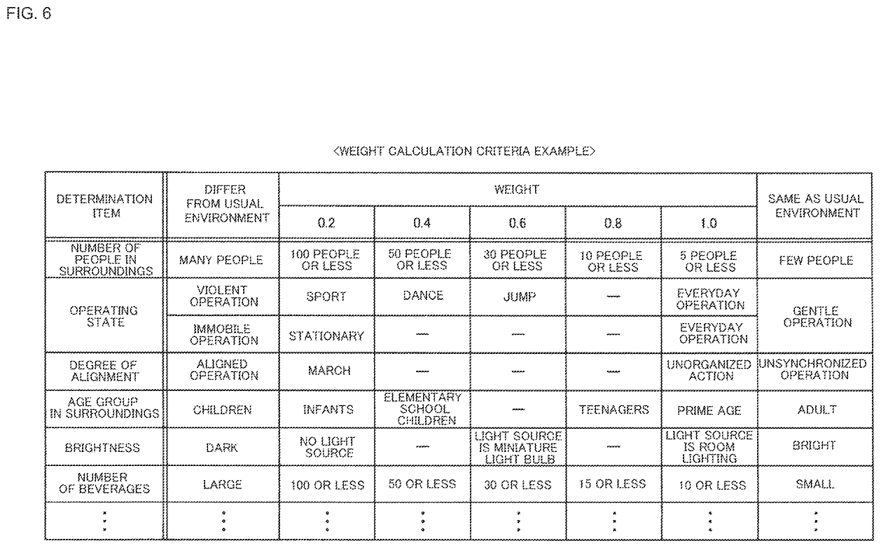

An example of criteria for an environmental weight will now be described with reference to FIG. 6. FIG. 6 is a diagram showing criteria of an environmental weight according to the embodiment of the present disclosure. FIG. 6 shows detailed numerical values of an environmental weight that is set in accordance with details of detected information. As shown in FIG. 6, the environmental weight indicates that, the smaller the numerical value, the greater the difference of the current operating environment from a usual operating environment, and the larger the numerical value, the greater the similarity of the current operating environment to the usual operating environment. When the numerical value of the environmental weight is 0.0, the current operating environment completely differs from the usual operating environment. In addition, when the numerical value of the environmental weight is 1.0, the current operating environment is the same as the usual operating environment. Furthermore, types of determination items, the number of determination items, and numerical values of weights are not limited to the example shown in FIG. 6.

A specific setting example of an environmental weight will be described. When the determination item is the number of people in the surroundings, for example, 0.2 is set when the number of people is 100 people or less, 0.4 is set when 50 people or less, 0.6 is set when 30 people or less, 0.8 is set when 10 people or less, and 1.0 is set when 5 people or less as an environmental weight. Accordingly, it is shown that the larger the number of people in the surroundings, the greater the difference from a usual environment, and the smaller the number of people in the surroundings, the greater the similarity to the usual environment.

When the determination item is an operating state, for example, 0.2 is set when the operation is a sport, 0.4 is set when the operation is a dance, 0.6 is set when the operation is a jump, and 1.0 is set in a case of an everyday operation as an environmental weight. Accordingly, it is shown that the closer the operation is to a violent operation, the greater the difference from a usual environment, and the closer the operation is to a gentle operation, the greater the similarity to the usual environment. In addition, when the operating state is a stationary state, 0.2 is set as the environmental weight, and when the operating state is an everyday operation, 1.0 is set as the environmental weight. Accordingly, it is shown that the closer the operation is to an immobile operation, the greater the difference from a usual environment, and the closer the operation is to a gentle operation, the greater the similarity to the usual environment.

When the determination item is a degree of alignment, for example, 0.2 is set when the operation is a march and 1.0 is set when the operation is unorganized action as an environmental weight. Accordingly, it is shown that the closer the operation is to an aligned operation, the greater the difference from a usual environment, and the closer the operation is to an unsynchronized operation, the greater the similarity to the usual environment.

When the determination item is an age group in the surroundings, for example, 0.2 is set when the age group is infants, 0.4 is set when the age group is elementary school children, 0.8 is set when the age group is teenagers, and 1.0 is set when the age group is prime age as an environmental weight. Accordingly, it is shown that the more the age group is children, the greater the difference from a usual environment, and the more the age group is adults, the greater the similarity to the usual environment.

When the determination item is brightness, for example, 0.2 is set when a light source is absent, 0.6 is set when the light source is a miniature light bulb, and 1.0 is set when the light source is room lighting as an environmental weight. Accordingly, it is shown that the darker the brightness, the greater the difference from a usual environment, and the closer the operation is to a gentle operation, the greater the similarity to the usual environment.

When the determination item is the number of beverages, for example, 0.2 is set when the number is 100 or less, 0.4 is set when 50 or less, 0.6 is set when 30 or less, 0.8 is set when 15 or less, and 1.0 is set when 10 or less as an environmental weight. Accordingly, it is shown that the larger the number of beverages, the greater the difference from a usual environment, and the smaller the remaining amount of beverage, the greater the similarity to the usual environment.

Determination items of the environmental weight are not limited to the examples described above and an arbitrary item may be set. For example, information related to an object present in the surroundings may be set as a determination item. Specifically, information related to an object present in the surroundings is whether or not the object is moving at high speed, whether or not the object is stationary, whether or not the object is fragile, whether or not the object is food or a beverage, whether or not the object is likely to fall, whether or not the object exists, or the like. In addition, information related to a person in the surroundings may be set as a determination item. Specifically, in addition to information related to the operations described above, information related to a person in the surroundings is information related to a posture such as whether or not the person is sitting or standing. Furthermore, information related to clothing may be set as a determination item. Specifically, information related to clothing is a presence or absence of shoes, whether or not clothing is worn at all, whether or not underwear is worn, or the like. In addition, race, type of language, noise level of the surroundings, the number of robots in the surroundings, interest from the surroundings (for example, an amount of line-of-sights directed from the surroundings), temperature, smell, altitude, whether or not outdoors or indoors, or the like may be set as a determination item. Furthermore, information related to a floor condition may be set as a determination item. Specifically, the floor conditions are a material of the floor, a presence or absence of differences in level, softness, shakiness, or the like. In addition, a wall condition, a ceiling condition, a space size, a state of living organisms in the surroundings, cleanness of the surroundings, or a communication environment may be set as a determination item. It should be noted at least one of the examples described above is set as a determination item.

As described above, an environmental weight that is set based on the determination items described above changes in accordance with a change in a surrounding environment of the robot 10. However, depending on contents of a change in the environment, there may be cases where an operation to be executed does not change before and after a change in the environmental weight. For example, a shape of a toilet seat, a space of a toilet compartment, and the like may change from one compartment to the next and, accordingly, an environmental weight may change. However, when the robot 10 goes around the toilet compartments to replenish toilet paper, the change in the environmental weight due to a change in the shape of a toilet seat, the space of a toilet compartment, and the like from one compartment to the next does not affect the operation performed by the robot 10. The robot 10 need only be capable of determining whether or not to replenish toilet paper based on an environmental weight that changes in accordance with a remaining amount of toilet paper. In consideration thereof, in the embodiment of the present disclosure, a prescribed threshold is set with respect to an environmental weight and an operation to be executed by the robot 10 is determined in accordance with whether or not the environmental weight is equal to or greater than the predetermined threshold. Accordingly, slight differences between a known operating environment and a current operating environment can be accommodated in a more flexible manner as compared to a case where an operation of the robot 10 is determined in accordance with every single environmental weight.

(2-2) Determining Unit 113

The determining unit 113 has a function of determining an operation of the robot 10 in a current operating environment of the robot 10. For example, the determining unit 113 determines at least one of a known operation that corresponds to a known operating environment and an operation that differs from the known operation as an operation of the robot 10 based on a comparison result between an environmental weight and a predetermined threshold which are input from the recognizing unit 111. Hereinafter, an operation that differs from a known operation may also be referred to as a new operation. In addition, the determining unit 113 outputs information related to the determined operation to the operation control unit 115.

(Determination of Known Operation)

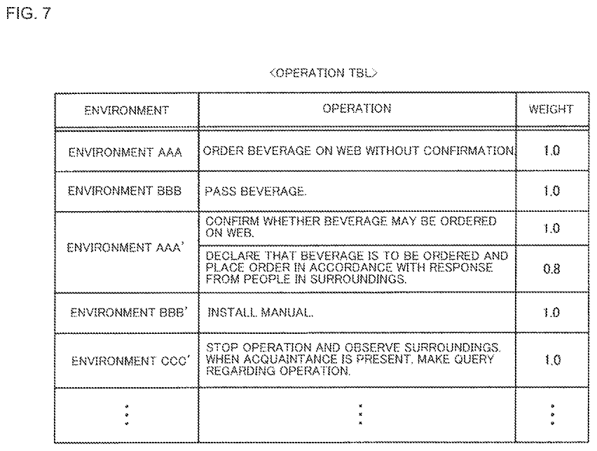

Determination of a known operation will now be described with reference to FIG. 7. FIG. 7 is a diagram showing an example of a known operation according to the embodiment of the present disclosure. Hereinafter, a weight set to each of candidates of a known operation will also be referred to as a weight of an operation. As shown in FIG. 7, a known operation of “Order a beverage on the Web without confirmation.” of which a weight of the operation is 1.0 is set to the environment AAA. In addition, a known operation of “Pass a beverage.” of which a weight of the operation is 1.0 is set to the environment BBB. Furthermore, known operations of “Confirm whether a beverage may be ordered on the Web” of which a weight of the operation is 1.0 and “Declare that a beverage is to be ordered and place an order in accordance with a response from people in the surroundings” of which a weight of the operation is 0.8 is set to the environment AAA′. In addition, a known operation of “Install a manual” of which a weight of the operation is 1.0 is set to the environment BBB′. Furthermore, a known operation of “Stop operation and observe surroundings. When an acquaintance is present, make a query regarding operation.” of which a weight of the operation is 1.0 is set to the environment CCC. It should be noted that contents of operations, the number of operations, and numerical values of weights of the operations that are set to each environment are not limited to the example shown in FIG. 7.

For example, when an environmental weight is equal to or more than a predetermined threshold and the recognizing unit 111 determines that a current operating environment is the same environment as a known operating environment, the determining unit 113 determines a known operation as an operation of the robot 10 in the current operating environment. When determining the known operation, the determining unit 113 compares weights of operations set to each of candidates of known operations and determines a known operation of which a weight of the operation is large as the operation of the robot 10 in the current operating environment. For example, in the case of the environment AAA′ shown in FIG. 7, an operation of which a weight of the operation is 1.0 and an operation of which a weight of the operation is 0.8 are set. Therefore, the determining unit 113 compares the weights of the respective operations and determines that the operation of which a weight of the operation is 1.0 is to be executed. In the cases of the environment AAA, the environment BBB, the environment BBB′, and the environment CCC shown in FIG. 7, since only one operation of which a weight of the operation is 1.0 is set, a determination that a known operation of which a weight of the operation is 1.0 is to be executed is made without comparing weights of operations.

(Determination of New Operation)

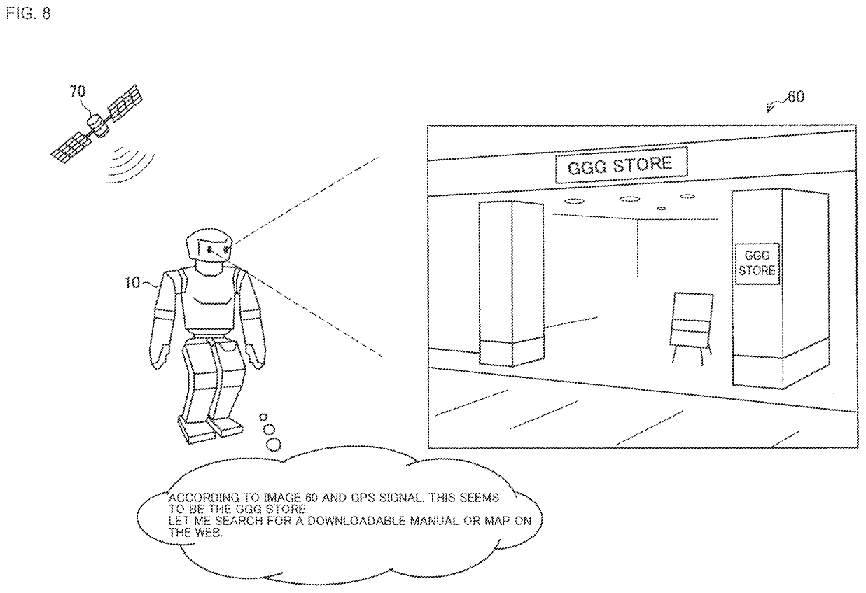

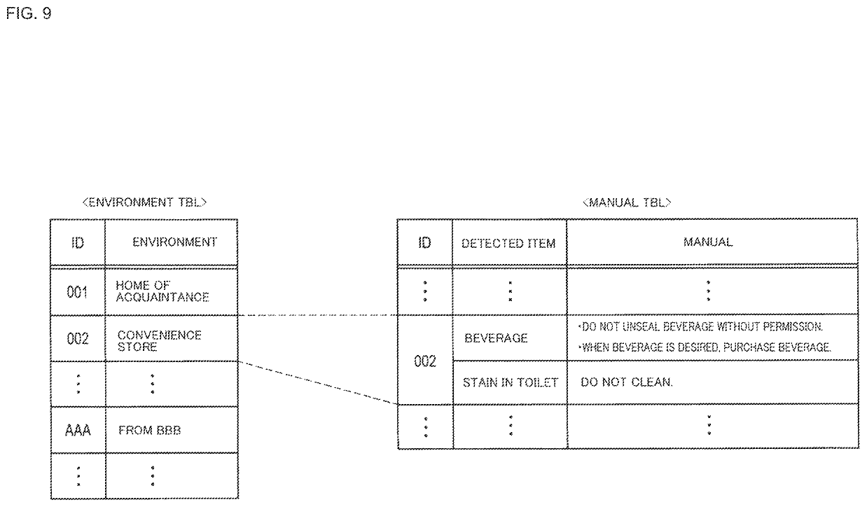

Determination of a new operation will now be described with reference to FIGS. 8 and 9. FIG. 8 is a diagram showing an example of detected information in a different environment according to the embodiment of the present disclosure.

For example, when an environmental weight is less than a predetermined threshold and the recognizing unit 111 determines that a current operating environment is a different environment from a known operating environment, the determining unit 113 executes operation confirmation processing for determining a new operation as an operation of the robot 10 in the current operating environment. When determining a new operation, for example, the determining unit 113 determines the new operation based on detected information and external information that is acquired from an external apparatus.

Specifically, the robot 10 makes a query to people in the surroundings and other robots and acquires answers to the query as detected information. The other robots are robots that are capable of providing an answer to the query. It is assumed that the robot 10, the people in the surroundings, and the other robots make queries and provide answers to each other by voice. Alternatively, the robot 10, the people in the surroundings, and the other robots may make queries and provide answers to each other by means other than voice. In addition, the determining unit 113 determines a new operation based on the answers. A query made by the robot 10 to a stranger or an unacquainted robot may accompany risk. Therefore, the robot 10 preferentially makes a query to a person who is an acquaintance or to an acquainted robot. For example, the robot 10 determines whether or not people in the surroundings are acquaintances by image recognition, voice recognition, or the like and preferentially makes a query to a person who is determined as an acquaintance. Among such acquaintances, a priority of queries to the owner of the robot 10 and family members of the owner is particularly high. When an acquaintance is not detected, the robot 10 may make a query to a stranger. In addition, based on identification information that enables a robot to be specified such as a mac address during communication, the determining unit 113 determines whether or not other robots in the surroundings are acquaintances and makes a query to a robot determined as an acquaintance.

When appropriate detected information cannot be acquired by the query, the robot 10 acquires information that enables a new operation to be determined by checking the surroundings. For example, as shown in FIG. 8, the robot 10 acquires an image 60 representing an environment around the robot 10 and, by analyzing the image 60, acquires information that enables a new operation to be determined. Specifically, by detecting a sign reading “GGG STORE” that is shown in the image 60, the determining unit 113 recognizes that a current position is the GGG STORE and determines an operation suitable for the GGG STORE as a new operation. In addition to signs, the determining unit 113 may search for information that enables a new operation to be determined mainly along street signs, logos, direction boards, and the like and determine a new operation based on the searched information. Furthermore, the determining unit 113 may recognize that the current position is the GGG STORE based on a GPS signal acquired from a GPS satellite 70.

After checking the surroundings and recognizing the environment, the determining unit 113 may acquire information related to the recognized environment and determine a new operation based on the information. Information related to the recognized environment is, for example, external information acquired from an external apparatus, and the acquired external information can include a manual related to an operation in the current operating environment. In addition, the information related to the recognized environment may be information acquired by a Web search. Furthermore, the information related to the recognized environment may be information detected by the sensor unit 100. Specifically, as shown in a speech bubble in FIG. 8, when the current position is recognized as the GGG STORE based on the image 60 and GPS information, the robot 10 searches for a downloadable manual or map on the Web. When information such as a manual or a map is acquired as a result of the search, the determining unit 113 determines a new operation based on the acquired information.

An example of a downloaded manual will now be described with reference to FIG. 9. FIG. 9 is a diagram showing an example of a manual according to the embodiment of the present disclosure. The manual shown in FIG. 9 represents a state of being stored in the storage unit 120. For example, when the determining unit 113 determines that the current position is a convenience store based on detected information related to the environment, the determining unit 113 searches for a manual of the convenience store on the Web and downloads the manual. Alternatively, the determining unit 113 may acquire a manual from an external apparatus installed in the convenience store via the network 50. After acquiring the manual, the determining unit 113 outputs the acquired manual to the storage unit 120 and causes the storage unit 120 to store the manual in the state shown in FIG. 9. As shown in FIG. 9, for example, the manual is stored separately as an environment TBL and a manual TBL. The environment TBL and the manual TBL are associated with each other by an ID. In the example shown in FIG. 9, the environment TBL has data items of an ID and an environment. For example, the ID of the environment TBL is assigned as serial numbers starting from 001. A name of a detected environment is registered in the environment of the environment TBL. In addition, the manual TBL has data items of an ID, a detected item, and a manual. An ID that corresponds to the environment TBL is registered in the ID of the manual TBL. Information detected in an environment that corresponds to the ID is registered as a detected item in the detected item of the manual TBL. A manual that corresponds to the detected item is registered in the manual of the manual TBL. For example, a manual in a case where a beverage is detected at a convenience store of which an ID is 002 is “Do not unseal a beverage without permission” and “When a beverage is desired, purchase the beverage”. In addition, a manual in a case where a stain in the toilet is detected at the convenience store of which an ID is 002 is “Do not clean”.

When neither the method of making a query to people in the surroundings or other robots nor the method of checking the surroundings results in the acquisition of suitable information, the determining unit 113 may make a determination to execute an operation along an operation flow carried by the robot 10. For example, the robot 10 first reduces a usual operating speed by around half. Next, the robot 10 observes people in the surroundings using calculation resources generated by reducing the operating speed and confirms whether or not a person performing an operation to the effect of stopping the operation of the robot 10 is present. The operation to the effect of stopping the operation is, for example, an operation involving a person shaking his/her head or an operation involving making a cross with arms. A person in the surroundings performing an operation to the effect of stopping the operation means that the operation being executed by the robot 10 is not appropriate in the current operating environment. When the robot 10 detects a person performing an operation to the effect of stopping the operation, the robot 10 stops the operation. When safety of the surroundings can be confirmed after stopping the operation, the robot 10 makes a query to the person having performed the operation to the effect of stopping the operation as to a reason or the like for performing the operation. In addition, the robot 10 may determine a new operation in accordance with an answer to the query. On the other hand, when the robot 10 does not detect a person performing an operation to the effect of stopping the operation, the robot 10 continues executing the operation and completes the operation.

The determining unit 113 may temporarily hold information related to an operation having been pointed out to be inappropriate. The information which is related to an operation having been pointed out to be inappropriate and which is temporarily held may be either reused or discarded after a certain period of time.

In addition, the determining unit 113 may have a person in the surroundings or another robot determine a new operation. For example, the determining unit 113 determines a candidate of a new operation in plurality, causes the robot 10 to repeatedly execute each candidate, and have a person in the surroundings or another robot evaluate execution results. In addition, based on the evaluation, the determining unit 113 may have a person in the surroundings or another robot determine a new operation from the candidates.

The determining unit 113 corrects a known operation in accordance with the current operating environment based on detected information and external information and determines an operation after the correction as a new operation. In addition, the determining unit 113 may newly generate an operation in accordance with the current operating environment based on detected information and external information and determine the generated operation as a new operation.

As described above, when the current operating environment is an environment that differs from a known operating environment, instead of making a usual determination as though the robot 10 is feeling anxiety, the determining unit 113 causes the robot 10 to make a query to a person or a robot in the surroundings or to check the surroundings. Accordingly, the robot 10 can avoid making a disastrous operation error in an unfamiliar operating environment. In addition, the robot 10 can add an operation suitable for the unfamiliar operating environment to a repertoire of operations to be executed by the robot 10.

(Determination of Determination Criteria)

The determining unit 113 determines determination criteria based on detected information and external information. For example, when a new operation is determined as an operation of the robot 10 in the current operating environment, the determining unit 113 determines determination criteria in accordance with the new operation based on detected information and external information. Specifically, when the environment AAA′ shown in FIG. 5 is determined as the current operating environment and a new operation is determined as an operation to be executed by the robot 10 in the environment AAA′, determination criteria in the environment AAA′ shown in FIG. 5 is determined as the determination criteria of the determined new operation. This similarly applies to the cases of the environment BBB′ and the environment CCC shown in FIG. 5. In addition, when the current operating environment is determined as the environment AAA′ but an operation to be executed by the robot 10 in the environment AAA′ is the same as an operation to be executed in the environment AAA, determination criteria of the environment AAA′ may be added to determination criteria of the environment AAA. In the case of the example shown in FIG. 5, a “house next door” that is a determination criterion of a current location of the environment AAA′ is added to a determination criterion of a current location of the environment AAA.

(Redetermination of Operation)

When it is determined that an operation of the robot 10 having been executed in the current operating environment is not appropriate based on an execution result of the operation of the robot 10, the determining unit 113 determines a new operation as an operation of the robot 10 in the current operating environment. It should be noted that an operation to be an object of determination may either be a known operation or a new operation. When the robot 10 executes a known operation in the current operating environment and the known operation is determined to be inappropriate, the determining unit 113 redetermines an operation that differs from the executed known operation as an operation of the robot 10 in the current operating environment. In addition, when the robot 10 executes a new operation in the current operating environment and the new operation is determined to be inappropriate, the determining unit 113 redetermines an operation that further differs from the executed new operation as an operation of the robot 10 in the current operating environment. The determining unit 113 determines whether or not an operation of the robot 10 having been executed in the current operating environment is appropriate based on, for example, an evaluation result by the evaluating unit 117 (to be described later) with respect to an execution result of the operation of the robot 10 having been executed in the current operating environment.

(2-3) Operation Control Unit 115

The operation control unit 115 has a function of controlling an operation by the robot 10. For example, the operation control unit 115 causes the robot 10 to execute an operation based on information related to the operation that is input from the determining unit 113. In addition, the operation control unit 115 outputs an execution result of the operation executed by the robot 10 to the evaluating unit 117.

(2-4) Evaluating Unit 117

The evaluating unit 117 has a function of evaluating an operation executed by the robot 10. For example, the evaluating unit 117 evaluates an operation executed by the robot 10 based on an execution result of the operation that is input from the operation control unit 115. In addition, the evaluating unit 117 outputs an evaluation result of the operation executed by the robot 10 to the determining unit 113.

For example, based on the execution result of the operation, the evaluating unit 117 evaluates whether or not the operation executed by the robot 10 is successful or whether or not the execution result is as expected by the user.

(2-5) Data Control Unit 119

The data control unit 119 has a function of controlling processing of data related to an operation by the robot 10. For example, the data control unit 119 generates a new operation determined by the determining unit 113 as storage data and causes the storage unit 120 to store the storage data. In addition, the data control unit 119 corrects a weight of an operation of the robot 10 based on an execution result of the operation. For example, when the execution result indicates that the operation of the robot 10 is successful or as expected by the user, the data control unit 119 corrects the weight to a larger value. On the other hand, when the execution result indicates that the operation of the robot 10 has failed or not as expected by the user, the data control unit 119 corrects the weight to a smaller value.

Since there is a limit to the number of pieces of storage data of operations that can be stored by the storage unit 120, it is not realistic to have the storage unit 120 of the robot 10 store all of the pieces of storage data of operations. In order to solve this problem, the data control unit 119 may have a storage unit 420 of the cloud server 40 store all of the pieces of storage data of operations. Accordingly, the data control unit 119 can control storage processing of storage data without exceeding an upper limit of a storage capacity of the storage unit 120. In addition, the data control unit 119 downloads, in advance, one or more pieces of storage data with highest likelihoods with respect to a known operating environment from the storage unit 420 before the determining unit 113 makes a determination of the current operating environment. For example, the data control unit 119 downloads pieces of storage data that respectively correspond to the environment AAA and the environment AAA′ in advance. Accordingly, when the current operating environment is an environment that is close to both the environment AAA and the environment AAA′, the data control unit 119 can readily accommodate both environments without delay.

(3) Storage Unit 120

The storage unit 120 has a function of storing data acquired by processing related to the robot 10. For example, the storage unit 120 stores storage data of an operation that is information related to an operation of the robot 10 input from the control unit 110. Information to be stored by the storage unit 120 is not limited to the example described above. For example, in addition to data output in processing of the control unit 110, the storage unit 120 may store programs such as various applications, data, and the like.

(4) Communication Unit 130

The communication unit 130 has a function of communicating with an external apparatus via the network 50. For example, the communication unit 130 outputs information received from an external apparatus during communication with the external apparatus to the control unit 110. Specifically, the communication unit 130 outputs information received from the external terminal 30 to the control unit 110. In addition, the communication unit 130 outputs information received from the cloud server 40 to the control unit 110.

Furthermore, the communication unit 130 transmits information input from the control unit 110 during communication with the external apparatus to the external apparatus. Specifically, the communication unit 130 transmits information input from the control unit 110 to the external terminal 30. In addition, the communication unit 130 transmits information input from the control unit 110 to the cloud server 40.

<1.2.2. Functional Configuration Example of Cloud Server 40>

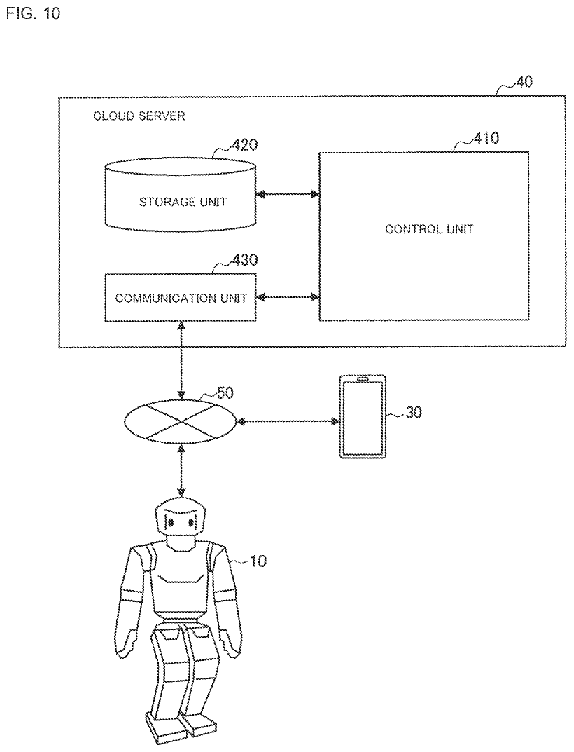

Next, a functional configuration example of the cloud server 40 according to the present embodiment will be described with reference to FIG. 10. FIG. 10 is a block diagram showing a functional configuration example of the cloud server 40 according to the embodiment of the present disclosure. As shown in FIG. 10, the cloud server 40 according to the present embodiment includes a communication unit 400, a control unit 410, and the storage unit 420.

(1) Communication Unit 400

The communication unit 400 has a function of communicating with an external apparatus via the network 50. For example, the communication unit 400 outputs information received from an external apparatus during communication with the external apparatus to the control unit 410. Specifically, the communication unit 400 outputs information received from the robot 10 to the control unit 410. In addition, the communication unit 400 outputs information received from the external terminal 30 to the control unit 410.

Furthermore, the communication unit 400 transmits information input from the control unit 410 during communication with the external apparatus to the external apparatus. Specifically, the communication unit 400 transmits information input from the control unit 410 to the robot 10. In addition, the communication unit 400 transmits information input from the control unit 410 to the external terminal 30.

(2) Control Unit 410

The control unit 410 has a function of controlling an entire operation by the cloud server 40. For example, the control unit 410 controls transmission/reception processing of information by the communication unit 400. In addition, the control unit 410 controls storage processing by the storage unit 420.

(3) Storage Unit 420

The storage unit 420 has a function of storing data related to an operation by the robot 10. For example, the storage unit 420, the communication unit 400, stores information related to an operation of the robot 10 that is received from the robot 10. Specifically, the storage unit 420 stores a repertoire of operations of the robot 10. In addition, the storage unit 420 may store storage data of operations executed by each of a plurality of robots 10. Furthermore, the storage unit 420 may store a repertoire of operations that are recommended within a control area of the robot 10. Information to be stored by the storage unit 420 is not limited to the examples described above. For example, in addition to data output in processing of the robot 10, the storage unit 420 may store programs such as various applications, data, and the like.

This concludes the description of a functional configuration example of the robot 10 and the cloud server 40 according to the present embodiment with reference to FIGS. 4 to 10. Next, an example of a flow of processing according to the present embodiment will be described.

<1.2.3. Flow of Processing>

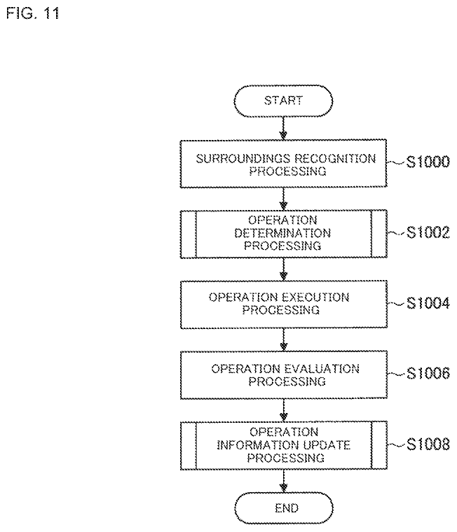

Hereinafter, an example of a flow of processing according to the present embodiment will be described with reference to FIGS. 11 to 14.

(1) Main Processing

First, an example of a flow of main processing according to the embodiment of the present disclosure will be described with reference to FIG. 11. FIG. 11 is a flow chart showing an example of a flow of main processing according to the present embodiment.

For example, as shown in FIG. 11, a robot 10 first performs surroundings recognition processing for recognizing a state of a surrounding environment of the robot 10 based on information detected by sensors or the like (step S1000). Next, based on a result of the surroundings recognition processing, the robot 10 performs operation determination processing for determining an operation to be executed by the robot 10 (step S1002). Detailed processing of the operation determination processing will be described later. Next, the robot 10 executes the operation determined by the operation determination processing (step S1004). Next, the robot 10 performs operation evaluation processing based on an execution result of the operation (step S1006). Finally, the robot 10 performs operation information update processing based on a result of the operation evaluation processing (step S1008), and ends processing.

(2) Operation Determination Processing

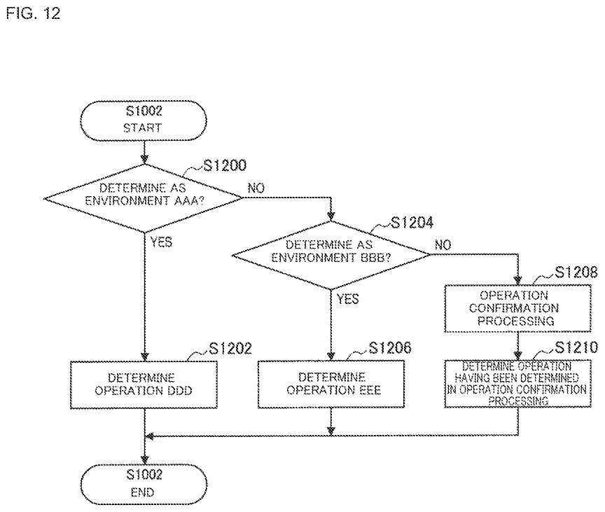

Next, an example of a flow of detailed processing of the operation determination processing according to the present embodiment will be described with reference to FIG. 12. FIG. 12 is a flow chart showing an example of a flow of detailed processing of operation determination processing according to the embodiment of the present disclosure.

For example, as shown in FIG. 12, the robot 10 first confirms whether or not a current operating environment of the robot 10 is the environment AAA based on a result of the surroundings recognition processing (step S1200). When the current operating environment is the environment AAA (YES in step S1200), the robot 10 makes a determination to execute an operation DDD that corresponds to the environment AAA (step S1202) and ends the operation determination processing of step S1002.

On the other hand, when the current operating environment is not the environment AAA (NO in step S1200), the robot 10 confirms whether or not the current operating environment is the environment BBB (step S1204). When the current operating environment is the environment BBB (YES in step S1204), the robot 10 makes a determination to execute an operation EEE that corresponds to the environment BBB (step S1206) and ends the operation determination processing of step S1002.

Furthermore, when the current operating environment is not the environment BBB (NO in step S1204), the robot 10 performs operation confirmation processing (step S1208). The robot 10 makes a determination to execute the operation determined by the operation confirmation processing (step S1210) and ends the operation determination processing of step S1002.

(3) Operation Information Update Processing

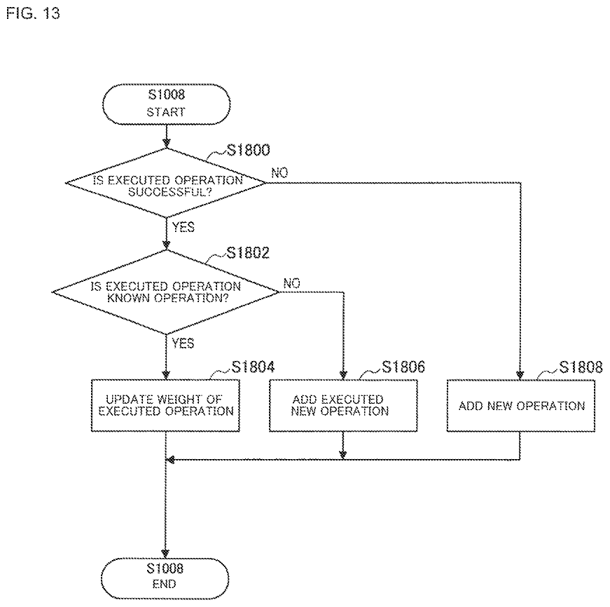

Next, an example of a flow of operation information update processing according to the present embodiment will be described with reference to FIG. 13. FIG. 13 is a flow chart showing an example of a flow of operation information update processing according to the embodiment of the present disclosure.

For example, as shown in FIG. 13, the robot 10 first confirms whether or not an executed operation has been successful (step S1800). When the executed operation has been successful (YES in step S1800), the robot 10 further confirms whether or not the executed operation is a known operation (step S1802). When the executed operation is a known operation (YES in step S1802), the robot 10 updates a weight of the executed operation in accordance with an execution result (step S1804) and ends the processing of step S1008. In addition, when the executed operation is not a known operation (NO in step S1802), the robot 10 adds the executed new operation to the repertoire (step S1806) and ends the processing of step S1008. Furthermore, when the executed operation has failed (NO in step S1800), the robot 10 adds the executed new operation to the repertoire (step S1808) and ends the processing of step S1008.

(4) Operation Determination Processing After Update

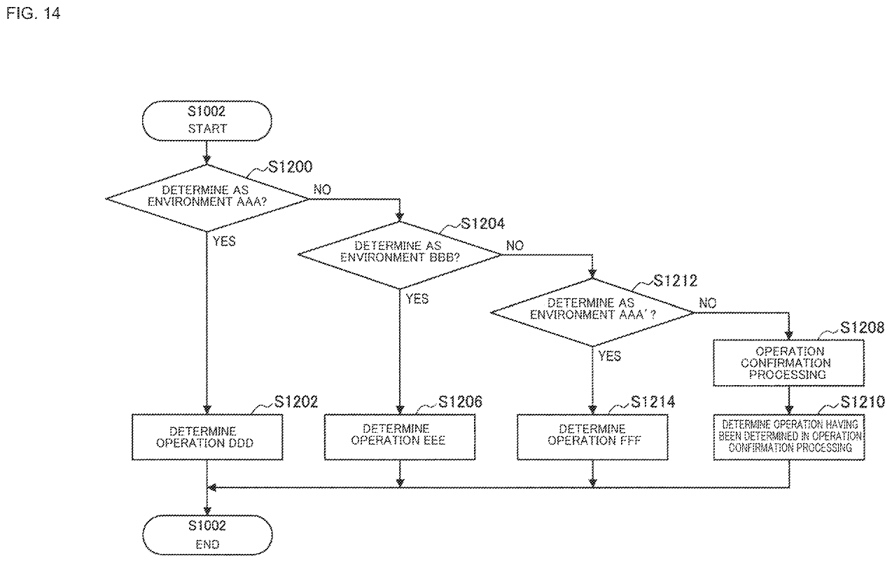

Finally, an example of a flow of operation determination processing after an update according to the present embodiment will be described with reference to FIG. 14. FIG. 14 is a flow chart showing an example of a flow of operation determination processing after an update according to the embodiment of the present disclosure.

When a determination criteria of the environment AAA′ and an operation FFF that corresponds to the environment AAA′ have been added by the operation information update processing of (3) described above, the flow chart of the operation determination processing shown in FIG. 12 is updated as represented by the flow chart shown in FIG. 14. For example, as shown in FIG. 14, when it is determined that the current operating environment is not the environment BBB in step S1204 (NO in step S1204), based on the added determination criteria of the environment AAA′, the robot 10 confirms whether or not the current operating environment is the environment AAA′ (step S1212). When the current operating environment is the environment AAA′ (YES in step S1212), the robot 10 makes a determination to execute the operation FFF that corresponds to the environment AAA′ (step S1214) and ends the operation determination processing of step S1002. On the other hand, when the current operating environment of the robot 10 is not the environment AAA′ (NO in step S1212), same processing steps as step S1208 and step S1210 described with reference to FIG. 12 are executed.

This concludes the description of an example of a flow of processing according to the present embodiment with reference to FIGS. 12 to 14. Next, modifications according to the present embodiment will be described.

### 2. Modifications

Hereinafter, modifications according to the embodiment of the present disclosure will be described. It should be noted that the modifications described below may be independently applied to the embodiment of the present disclosure or may be applied to the embodiment of the present disclosure in combination with each other. In addition, the modifications may be applied in place of configurations described in the embodiment of the present disclosure or may be additionally applied with respect to the configurations described in the embodiment of the present disclosure.

(1) First Modification

While an example in which a control object is the robot 10 has been explained in the embodiment described above, the control object is not limited to the example and may alternatively be an unmanned aerial vehicle called a drone or a vehicle (for example, personal mobility represented by Segway).

(2) Second Modification

While an example in which a control object makes a query to people in the surroundings or other robots by voice output has been explained in the embodiment described above, the control object may make a query by a method other than voice output. For example, the control object makes a query by gesturing, signing, displaying a text, displaying an image, displaying a moving image, or the like. In addition, the control object may present a query to a communication device such as a smartphone, a tablet terminal, or a PC via a network.

(3) Third Modification

While an example in which a person answers a query from the control object by voice been explained in the embodiment described above, a person may provide an answer by a method other than voice. For example, a person provides an answer by gesturing, signing, operating a master-slave apparatus, direct teaching, and the like. In addition, a person may provide an answer via a network using a communication device such as a smartphone, a tablet terminal, or a PC being connected to the network. Furthermore, a person may provide an answer using information measured by electromyographic measurement or electroencephalographic measurement. In addition, a person may provide an answer using a control device.

This concludes the description of modifications according to the present embodiment. Next, a hardware configuration of a control apparatus according to the present embodiment will be described.

### 3. Example of Hardware Configuration

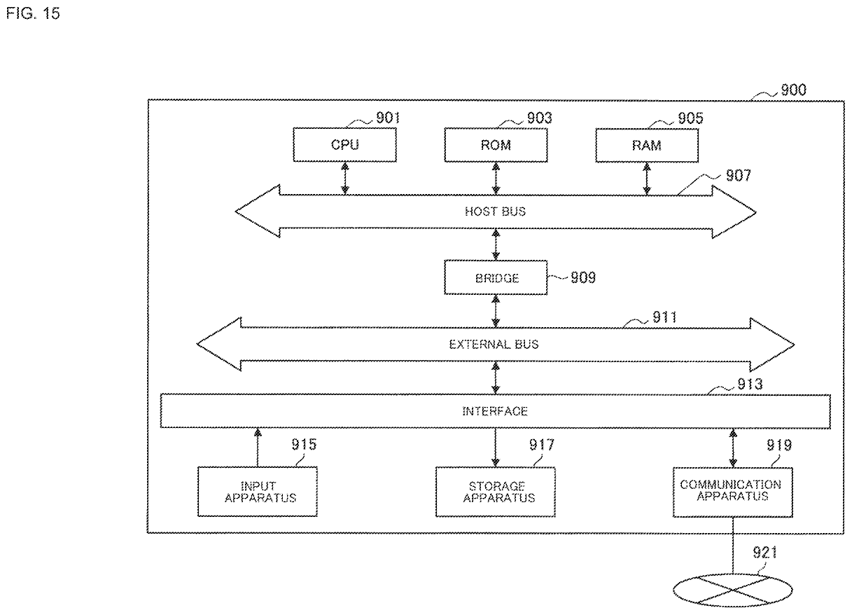

Hereinafter, an example of a hardware configuration of a robot according to the present embodiment will be described with reference to FIG. 15. FIG. 15 is a block diagram showing an example of a hardware configuration of a robot according to the embodiment of the present disclosure. For example, a robot 900 shown in FIG. 15 can realize the robot 10 shown in FIG. 4. Control processing by the robot 10 according to the present embodiment is realized by cooperation between software and hardware to be described below.

As shown in FIG. 15, the robot 900 includes a CPU (Central Processing Unit) 901, a ROM (Read Only Memory) 903, and a RAM (Random Access Memory) 905. In addition, the robot 900 includes a host bus 907, a bridge 909, an external bus 911, an interface 913, an input apparatus 915, a storage apparatus 917, and a communication apparatus 919. The hardware configuration described here is merely an example and a part of the components may be omitted. In addition, the hardware configuration may further include components other than the components shown here.

(CPU 901, ROM 903, and RAM 905)

For example, the CPU 901 functions as an arithmetic processing apparatus or a control apparatus and, in accordance with various programs recorded in the ROM 903, the RAM 905, or the storage apparatus 917, controls all operations of the respective components or a part thereof. The ROM 903 is means that stores programs to be loaded to the CPU 901, data used for calculations, and the like. For example, the RAM 905 temporarily or persistently stores programs to be loaded to the CPU 901, various parameters that appropriately change when executing the programs, and the like. These components are connected to each other by the host bus 907 that is constituted by a CPU bus or the like. The CPU 901, the ROM 903, and the RAM 905 can realize functions of the control unit 110 described with reference to FIG. 4 by, for example, cooperating with software.

(Host Bus 907, Bridge 909, External Bus 911, and Interface 913)

For example, the CPU 901, the ROM 903, and the RAM 905 are connected to each other via the host bus 907 that is capable of high-speed data transfer. On the other hand, for example, the host bus 907 is connected to the external bus 911 with a relatively low data transfer rate via the bridge 909. In addition, the external bus 911 is connected to various components via the interface 913.

(Input Apparatus 915)

For example, the input apparatus 915 is realized by an apparatus to be used by the user to input information such as a mouse, a keyboard, a touch panel, a button, a microphone, a switch, or a lever. In addition, for example, the input apparatus 915 may be a remote-controlled apparatus that utilizes infrared light or other radio waves or an externally-connected device such as a mobile phone or a PDA that accommodates operations of the robot 900. Furthermore, for example, the input apparatus 915 may include an input control circuit or the like which generates an input signal based on information input by the user using the input means described above and which outputs the generated input signal to the CPU 901. By operating the input apparatus 915, the user of the robot 900 can input various kinds of data and issue instructions to perform processing operations with respect to the robot 900.

In addition to the above, the input apparatus 915 can be constituted by an apparatus that senses information related to the user. For example, the input apparatus 915 can include various types of sensors such as an image sensor (for example, a camera), a depth sensor (for example, a stereo camera), an acceleration sensor, a gyroscope sensor, a geomagnetic sensor, a light sensor, a sound sensor, a ranging sensor, and a force sensor. Furthermore, the input apparatus 915 may acquire information related to a state of the robot 900 itself such as a posture or a movement speed of the robot 900 and information related to a surrounding environment of the robot 900 such as brightness or a noise level of the surroundings of the robot 900. In addition, the input apparatus 915 may include a GNSS (Global Navigation Satellite System) module which receives a GNSS signal from a GNSS satellite (for example, a GPS signal from a GPS (Global Positioning System) satellite) to measure positional information including a latitude, a longitude, and an altitude of the apparatus. Alternatively, with respect to positional information, the input apparatus 915 may sense a position from Wi-Fi (registered trademark), transmission to and reception from a mobile phone, a PHS, a smartphone, or the like, short-range communication, and the like. For example, the input apparatus 915 can realize functions of the sensor unit 100 described with reference to FIG. 4.

(Storage Apparatus 917)

The storage apparatus 917 is an apparatus for data storage having been constructed as an example of a storage unit of the robot 900. For example, the storage apparatus 917 is realized by a magnetic storage portion device such as an HDD, a semiconductor storage device, an optical storage device, a magneto-optical storage device, or the like. The storage apparatus 917 may include a storage medium, a recording apparatus that records data on the storage medium, a reading apparatus that reads data from the storage medium, a deleting apparatus that deletes data recorded on the storage medium, and the like. The storage apparatus 917 stores programs to be executed by the CPU 901, various kinds of data, various kinds of data acquired from the outside, and the like. For example, the storage apparatus 917 can realize functions of the storage unit 120 described with reference to FIG. 4.

(Communication Apparatus 919)

The communication apparatus 919 is, for example, a communication interface constituted by a communication device or the like for connecting to a network 921. For example, the communication apparatus 919 is a communication card for a wired or wireless LAN (Local Area Network), LTE (Long Term Evolution), Bluetooth (a registered trademark), or WUSB (Wireless USB). In addition, the communication apparatus 919 may be a router for optical communication, a router for ADSL (Asymmetric Digital Subscriber Line), or a modem or the like for various kinds of communication. For example, the communication apparatus 919 is capable of transmitting and receiving signals and the like in conformity to a predetermined protocol such as TCP/IP to and from the Internet or another communication device.

The network 921 is a wired or wireless transmission line for information transmitted from apparatuses connected to the network 921. For example, the network 921 may include a public line network such as the Internet, a telephone line network, or a satellite communication network, various types of LAN (Local Area Network) including the Ethernet (registered trademark), a WAN (Wide Area Network), or the like. In addition, the network 921 may include a dedicated line network such as an IP-VPN (Internet Protocol-Virtual Private Network).

This concludes the description of an example of a hardware configuration of a robot according to the present embodiment with reference to FIG. 15. The respective components described above may be realized using generic members or realized by hardware having been specialized for the functions of the respective components. Therefore, the hardware configuration to be utilized can be modified as deemed appropriate in accordance with a technological level at the time of implementation of the present embodiment.

### 4. Summary

As described above, the control apparatus according to the present embodiment compares a weight related to a current operating environment calculated based on detected information that is detected at a current position of a control object with a predetermined threshold that is set to determination criteria of a known operating environment. In addition, based on a comparison result, the control apparatus determines an operation of the control object in the current operating environment. Accordingly, the control apparatus can evaluate whether or not an operation set to the known operating environment is suitable as an operation to be executed in the current operating environment.

Therefore, a novel and improved control apparatus, control method, and program capable of determining an operation that is suitable for a current operating environment can be provided.

While a preferred embodiment of the present disclosure has been described in detail with reference to the accompanying drawings, the technical scope of the present disclosure is not limited thereto. It will be obvious to a person with ordinary skill in the art to which the technical field of the present disclosure pertains that various modifications and changes can be arrived at without departing from the technical ideas described in the appended claims and, as such, it is to be understood that such modifications and changes are to be naturally covered in the technical scope of the present disclosure.

In addition, the series of processing by the respective apparatuses described in the present specification may be realized by any of software, hardware, and a combination of software and hardware. Programs that constitute the software are stored in advance in, for example, recording media (non-transitory media) provided inside or outside each apparatus. In addition, for example, each program is loaded to a RAM upon execution by a computer to be executed by a processor such as a CPU.

Furthermore, the steps of processing described using flow charts in the c specification need not necessarily be executed in the illustrated orders. Some of the processing steps may be executed in parallel. In addition, additional processing steps may be adopted or a part of the processing steps may be omitted.

In addition, the advantageous effects described in the present specification are merely descriptive or exemplary and not restrictive. In other words, the technique according to the present disclosure can produce, in addition to or in place of the advantageous effects described above, other advantageous effects that will obviously occur to those skilled in the art from the description of the present specification.

The following configurations are also covered in the technical scope of the present disclosure.

(1)

A control apparatus including:

a control unit configured to compare a weight related to a current operating environment calculated based on detected information that is detected at a current position of a control object with a predetermined threshold that is set to determination criteria of a known operating environment and, based on a comparison result, determine an operation of the control object in the current operating environment.

(2)

The control apparatus according to (1), wherein the control unit is configured to determine, based on the comparison result, at least one of a known operation that corresponds to the known operating environment and an operation that differs from the known operation as an operation of the control object.

(3)

The control apparatus according to (2), wherein the control unit is configured to determine that, when the weight is less than the predetermined threshold, the current operating environment is an environment that differs from the known operating environment, and determines the different operation as an operation of the control object in the current operating environment.

(4)

The control apparatus according to (3), wherein the control unit is configured to calculate a sum of the weights calculated with respect to each of a plurality of the determination criteria and a sum of predetermined thresholds set to each of the plurality of determination criteria, and compare the sum of the weights and the sum of the predetermined thresholds with each other.

(5)

The control apparatus according to (4), wherein the control unit is configured to compare the weight calculated with respect to each of a plurality of the determination criteria and a predetermined threshold that is set to each of the plurality of determination criteria that correspond to each of the weights with each other.

(6)

The control apparatus according to any one of (2) to (5), wherein the control unit is configured to determine that, when the weight is equal to or more than the predetermined threshold, the current operating environment is an identical environment as the known operating environment, and determines the known operation as an operation of the control object in the current operating environment.

(7)

The control apparatus according to any one of (2) to (6), wherein the control unit is configured to determine, when an operation of the control object having been executed in the current operating environment is not appropriate based on an execution result of the operation of the control object, the different operation as an operation of the control object in the current operating environment.

(8)

The control apparatus according to any one of (2) to (7), wherein the control unit is configured to determine the different operation and the determination criteria based on the detected information and external information acquired from an external apparatus.

(9)

The control apparatus according to (8), wherein the control unit is configured to adopt the known operation having been corrected in accordance with the current operating environment as the different operation based on the detected information and the external information.

(10)

The control apparatus according to (8) or (9), wherein the control unit is configured to adopt an operation having been newly generated in accordance with the current operating environment as the different operation based on the detected information and the external information.

(11)

The control apparatus according to any one of (8) to (10), wherein the control unit is configured to determine, when the different operation is determined as an operation of the control object in the current operating environment, the determination criteria in accordance with the different operation based on the detected information and the external information.

(12)

The control apparatus according to any one of (6) to (11), wherein the control unit is configured to compare weights set to each of candidates of the known operation and determine the known operation of which a weight set to each of candidates of the known operation is large as an operation of the control object in the current operating environment.

(13)

The control apparatus according to (12), wherein the control unit is configured to correct a weight set to each of candidates of the known operation based on an execution result of an operation of the control object.

(14)

The control apparatus according to any one of (8) to (11), wherein the external information can include a manual related to an operation in the current operating environment that is acquired from the external apparatus.

(15)

The control apparatus according to any one of (1) to (14), wherein the detected information can include answers to queries directed to people and robots in the surroundings.

(16)

A control method executed by a processor, the method including:

comparing a weight related to a current operating environment calculated based on detected information that is detected at a current position of a control object with a predetermined threshold that is set to determination criteria of a known operating environment and, based on a comparison result, determining an operation of the control object in the current operating environment.

(17)

A program for causing a computer to function as:

a control unit configured to compare a weight related to a current operating environment calculated based on detected information that is detected at a current position of a control object with a predetermined threshold that is set to determination criteria of a known operating environment and, based on a comparison result, determine an operation of the control object in the current operating environment.

### REFERENCE SIGNS LIST

10 Robot

30 External terminal

40 Cloud server

50 Network

100 Sensor unit

110 Control unit

111 Recognizing unit

113 Determining unit

115 Operation control unit

117 Evaluating unit

119 Data control unit

120 Storage unit

130 Communication unit

400 Communication unit

410 Control unit

420 Storage unit

1. A control apparatus comprising:
a control unit configured to compare a weight related to a current operating environment calculated based on detected information that is detected at a current position of a control object with a predetermined threshold that is set to determination criteria of a known operating environment and, based on a comparison result, determine an operation of the control object in the current operating environment.

2. The control apparatus according to claim 1, wherein the control unit is configured to determine, based on the comparison result, at least one of a known operation that corresponds to the known operating environment and an operation that differs from the known operation as an operation of the control object.

3. The control apparatus according to claim 2, wherein the control unit is configured to determine that, when the weight is less than the predetermined threshold, the current operating environment is an environment that differs from the known operating environment, and determines the different operation as an operation of the control object in the current operating environment.

4. The control apparatus according to claim 3, wherein the control unit is configured to calculate a sum of the weights calculated with respect to each of a plurality of the determination criteria and a sum of predetermined thresholds set to each of the plurality of determination criteria, and compare the sum of the weights and the sum of the predetermined thresholds with each other.

5. The control apparatus according to claim 4, wherein the control unit is configured to compare the weight calculated with respect to each of a plurality of the determination criteria and a predetermined threshold that is set to each of the plurality of determination criteria that correspond to each of the weights with each other.

6. The control apparatus according to claim 2, wherein the control unit is configured to determine that, when the weight is equal to or more than the predetermined threshold, the current operating environment is an identical environment as the known operating environment, and determines the known operation as an operation of the control object in the current operating environment.

7. The control apparatus according to claim 2, wherein the control unit is configured to determine, when an operation of the control object having been executed in the current operating environment is not appropriate based on an execution result of the operation of the control object, the different operation as an operation of the control object in the current operating environment.

8. The control apparatus according to claim 2, wherein the control unit is configured to determine the different operation and the determination criteria based on the detected information and external information acquired from an external apparatus.

9. The control apparatus according to claim 8, wherein the control unit is configured to adopt the known operation having been corrected in accordance with the current operating environment as the different operation based on the detected information and the external information.

10. The control apparatus according to claim 8, wherein the control unit is configured to adopt an operation having been newly generated in accordance with the current operating environment as the different operation based on the detected information and the external information.

11. The control apparatus according to claim 8, wherein the control unit is configured to determine, when the different operation is determined as an operation of the control object in the current operating environment, the determination criteria in accordance with the different operation based on the detected information and the external information.

12. The control apparatus according to claim 6, wherein the control unit is configured to compare weights set to each of candidates of the known operation and determine the known operation of which a weight set to each of candidates of the known operation is large as an operation of the control object in the current operating environment.

13. The control apparatus according to claim 12, wherein the control unit is configured to correct a weight set to each of candidates of the known operation based on an execution result of an operation of the control object.

14. The control apparatus according to claim 8, wherein the external information can include a manual related to an operation in the current operating environment that is acquired from the external apparatus.

15. The control apparatus according to claim 1, wherein the detected information can include answers to queries directed to people and robots in the surroundings.

16. A control method executed by a processor, the method comprising:
comparing a weight related to a current operating environment calculated based on detected information that is detected at a current position of a control object with a predetermined threshold that is set to determination criteria of a known operating environment and, based on a comparison result, determining an operation of the control object in the current operating environment.

17. A program for causing a computer to function as:
a control unit configured to compare a weight related to a current operating environment calculated based on detected information that is detected at a current position of a control object with a predetermined threshold that is set to determination criteria of a known operating environment and, based on a comparison result, determine an operation of the control object in the current operating environment.
